(19) United States
(12) Patent Application Publication
(10) Pub. No.: US 2026/0025583 A1
(43) Pub. Date: Jan. 22, 2026

(54) OPTICAL IMAGE STABILIZATION SYSTEM AND METHOD OF CONTROLLING OPTICAL IMAGE STABILIZATION

(71) Applicant: HUAWEI TECHNOLOGIES CO., LTD., Shenzhen (CN)

(72) Inventors: Takashi Yamamoto, Tokyo (JP); Masato Nishizawa, Tokyo (JP); Masahiko Koyanagi, Tokyo (JP); Tsukasa Murata, Tokyo (JP); Xing Li, Shanghai (CN)

(73) Assignee: HUAWEI TECHNOLOGIES CO., LTD., Shenzhen,Guangdong (CN)

(21) Appl. No.: 19/343,960

(22) Filed: Sep. 29, 2025

Related U.S. Application Data
(63) Continuation of application No. PCT/CN2023/107763, filed on Jul. 17, 2023.

(51) Int. Cl. H04N 23/68

(52) U.S. Cl. CPC H04N 23/6812; H04N 23/687

(57) ABSTRACT

An optical image stabilization system comprises: a detection unit configured to detect motion of a compensation target object in each frame of a moving image, wherein the compensation target object is an optical system, a camera module or an image sensor; and a driver configured to perform a compensation of a blur of an image by moving the compensation target object so as to cancel the motion of a detected compensation target object. A period corresponding to each frame includes a first period during which an exposure is carried out and a second period during which the exposure is suspended. The driver is configured to initiate the compensation so as to perform the compensation at least in part of the first period, and to suspend the compensation so as not to perform the compensation at least in part of the second period.

### CROSS-REFERENCE TO RELATED APPLICATIONS

This application is a continuation of International Application No. PCT/CN2023/107763, filed on Jul. 17, 2023, the disclosure of which is hereby incorporated by reference in its entirety.

### TECHNICAL FIELD

The present disclosure relates to an optical image stabilization system and a method of controlling optical image stabilization, and more particularly to an optical image stabilization system and a method of controlling optical image stabilization, an imaging device and a camera module that move a lens, an image sensor, or the like to cancel relative movement of a subject within a screen due to camera shake.

### BACKGROUND

Optical Image Stabilization (OIS) is widely used in camera modules mounted on portable devices such as smartphones and tablet PCs, and other cameras. The optical image stabilization is a function for preventing camera shake during video photographing and preview display. In the optical image stabilization, a trajectory of the camera shake is generated based on an angular velocity signal obtained from a gyro sensor, an acceleration signal obtained from an acceleration sensor, and so on. Then, compensation is carried out to suppress occurring of blurring of an image so as to cancel movement along the trajectory of the camera shake. In image compensation, an OIS method for moving or rotating a lens, an image sensor, or the camera module itself in a direction that cancels out the trajectory of the camera shake during an exposure period is known. In the optical image stabilization, the method of moving the lens may be referred to as a lens-shift stabilization. Also, the method for moving the image sensor may be referred to as sensor-shift stabilization. Furthermore, the method of moving the camera module itself may be referred to as module tilt stabilization.

There are mechanical limitations in any of the above OIS systems. As a mechanical limitation, for example, the lens-shift type and the sensor-shift type OIS systems have limitations on the amount of movement. In addition, the module tilt OIS system has a maximum angle of rotation. These mechanical limitations limit practical performance of the OIS. For example, in continuous use of the camera such as photographing a moving image, an orientation of the camera easily exceeds the mechanical limitation of the OIS. In order to deal with such a situation, when the movement amount of the lens or image sensor, or the rotation angle of the camera module approaches the mechanical limitation, the imaging device transitions from the normal state to a special state, commonly referred to as a “Pan-Tilt,” and carries out control in accordance with this state. For example, upon transferring from the normal state to a pan-tilt state, the OIS is continued by performing actions to avoid mechanical limitation. For example, the imaging device forcibly changes the position of the lens, the image sensor, and the like in a direction that approaches a reference position. This method is widely used, and it has been put into practical use and commercialized. However, the ability to perform blurring compensation during the exposure period in this pan-tilt state is significantly deteriorated compared to the normal state. In addition, this method requires a process for detecting the pan-tilt state.

Thus, in the conventional OIS method, the method of detection and control pan-tilt state, the ability for blurring compensation is significantly deteriorated as long as continuous OIS operations are performed under mechanically limited circumstances. Furthermore, the load caused by the processing for detecting the pan-tilt state increases.

### SUMMARY

The present disclosure provides an optical image stabilization system and a method of controlling optical image stabilization that can improve the compensation ability in the pan-tilt state.

According to the first aspect, there is provided an optical image stabilization system, comprising:
a detection unit configured to detect motion of a compensation target object in each frame of a moving image, wherein the compensation target object is an optical system, a camera module or an image sensor; and
a driver configured to perform compensation of blur of an image by moving the compensation target object so as to cancel the motion of the detected compensation target object,
wherein a period corresponding to each frame includes a first period during which exposure is carried out and a second period during which the exposure is suspended, and wherein the driver initiates the compensation so as to perform the compensation at least in part of the first period, and suspends the compensation so as not to perform the compensation at least in part of the second period.

According to the first aspect, the OIS control initiates the compensation so as to perform the compensation at least in part of the first period, and suspends the compensation so as not to perform the compensation at least in part of the second period. Accordingly, the quality of the moving image can be improved by suppressing the image blur in the pan-tilt state.

In one embodiment, the driver is further configured to move the compensation target object to a predetermined reference position in the second period.

According to this embodiment, it is possible to reduce power consumption required for the movement of the compensation target object by removing the DC component from the fragmented target value.

In one embodiment, the reference position is a center of a mechanism for moving the compensation target object.

According to this embodiment, power consumption required for the movement of the camera module can be reduced by taking the center of the mechanism for moving the compensation target object as the reference position.

In one embodiment, the reference position is an optical center of the compensation target object.

According to this embodiment, by using the optical center as the reference position, the power consumption required for moving the optical system can be reduced.

In one embodiment, the driver is further configured to move the compensation target object to maximize an operable range of the compensation target object in the second period based on motion of the compensation target object detected in the previous first period.

According to this embodiment, the ability of optical image stabilization can be improved by moving the compensation target object to maximize the operable range of the compensation target object.

In one embodiment, the driver is further configured to shorten an exposure period in the subsequent frame when the motion of the compensation target object detected in the previous preceding first period exceeds the operable range of the compensation target object.

According to this embodiment, when the motion of the compensation target object exceeds the operable range of the compensation target object, the exposure period in the subsequent frame is shortened. Accordingly, it is possible to reduce the period of time during which the compensation target reaches the limit of the operable range of an actuator and effect of the stabilization is impaired.

In one embodiment, the driver is further configured to move the compensation target object to the reference position at a constant speed during a period from an end of the compensation to a start of a next compensation.

According to this embodiment, during the period from the end of the compensation to the next start of the compensation, the power consumption required for moving the compensation target object to the reference position can be suppressed at a constant speed.

In one embodiment, the driver is further configured to move the compensation target object such that a period of time during which the compensation target object stops moving at the reference position occurs during a period from an end of the compensation to a start of a next compensation.

According to this embodiment, the rapid movement of the compensation target object to the reference position can ensure that the compensation target object is in the reference position before the start of the OIS control of the next frame even when a blank period is short.

In one embodiment, a start time of the compensation is different from a start time of an exposure period.

According to this embodiment, the start time of the compensation and the start time of the exposure period are different, and thus the quality of the moving image can be improved by suppressing image blur in the pan-tilt state even in the case where the response is disturbed in the feedback control based on the movement of the camera module.

In one embodiment, an end time of the compensation is different from an end time of an exposure period.

According to this embodiment, the end time of the compensation and the end time of the exposure period are different, and thus the quality of the moving image can be improved by suppressing image blur in the pan-tilt state even in the case where the response is disturbed in the feedback control based on the movement of the camera module.

According to the second aspect, there is provided a method of optical image stabilization, comprising:
detecting motion of a compensation target object in each frame of a moving image, wherein the compensation target object is an optical system, a camera module or an image sensor; and
performing compensation of blur of an image by moving the compensation target object so as to cancel the motion of the detected compensation target object to,
wherein a period corresponding to each frame includes a first period during which exposure is carried out and a second period during which the exposure is suspended, and
wherein in the performing compensation, the compensation starts at least in part of the first period, and the compensation suspends so as not to perform the compensation at least in part of the second period.

According to the second aspect, the OIS control initiates the compensation to make the compensation at least in part of the first period and suspends the compensation to avoid making the compensation at least in part of the second period. Accordingly, the quality of the moving image is improved by suppressing the image blur in the pan-tilt state.

In one embodiment, the performing compensation comprises:
moving the compensation target object to a predetermined reference position in the second period.

In one embodiment, the reference position is a center of a mechanism for moving the compensation target object.

In one embodiment, the reference position is an optical center of the compensation target object.

In one embodiment, the performing compensation comprises moving the compensation target object to maximize an operable range of the compensation target object in the second period based on motion of the compensation target object detected in the previous first period.

In one embodiment, the method further comprises shortening an exposure period in the subsequent frame when the motion of the compensation target object detected in the previous preceding first period exceeds the operable range of the compensation target object.

In one embodiment, the moving the compensation target object to a predetermined reference position comprises moving the compensation target object to the reference position at a constant speed during a period from an end of the compensation to a start of a next compensation.

In one embodiment, the moving the compensation target object to a predetermined reference position comprises moving the compensation target object such that a period of time during which the compensation target object stops moving at the reference position occurs during a period from an end of the compensation to a start of a next compensation.

In one embodiment, a start time of the compensation is different from a start time of an exposure period.

In one embodiment, an end time of the compensation is different from an end time of an exposure period.

According to the third aspect, there is provided a camera module comprising the above-described optical image stabilization system.

According to the fourth aspect, there is provided an imaging device comprising the above-described optical image stabilization system.

### BRIEF DESCRIPTION OF DRAWINGS

To describe the technical solutions in the embodiments more clearly, the following briefly describes the accompanying drawings required for describing the present embodiments. Apparently, the accompanying drawings in the following description depict merely some of the possible embodiments, and a person of ordinary skill in the art may still derive other drawings, without creative efforts, from these accompanying drawings, in which:

FIG. 1 illustrates a basic configuration of an optical image stabilization system according to an embodiment of the present disclosure.

FIG. 2 illustrates a diagram illustrating motion of a smartphone and a camera module. FIG. 2(a) illustrates motion of the camera module when a body of a smartphone is in a reference position, and FIG. 2(b) illustrates motion of the camera module when the body of the smartphone moves by the angular displacement θ_{P} from the reference position.

FIG. 3 illustrates an example of a graph showing values of acquired angular displacement θ_{P}.

FIG. 4 illustrates an example of a graph showing the values of the obtained angular displacement θ_{P} and calculated angle θ_{IS}.

FIG. 5 illustrates a graph showing values of angle θ_{P}−θ_{IS}, FIG. 5(a) is a graph showing a value of θ_{P}−θ_{IS}, and FIG. 5(b) is an enlarged view of the circled portion in FIG. 5(a).

FIG. 6 illustrates an example functional block diagram related to the conventional OIS method.

FIG. 7 illustrates an example functional block diagram related to an OIS according to one embodiment.

FIG. 8 illustrates detailed communication between a signal processing unit and a feedback control unit.

FIG. 9 illustrates a flowchart of a method of controlling optical image stabilization according to an embodiment.

FIG. 10 illustrates a graph showing motion of a camera module.

FIG. 11 illustrates an example of fragmented target values.

FIG. 12 illustrates an example of fragmented new target values.

FIG. 13 illustrates a diagram showing a method of generating a new target value according to an embodiment.

FIG. 14 illustrates a result of simulation of calculating a target value according to an embodiment. FIG. 14(a) shows angular displacement and motion of an image indicated by a motion signal. FIG. 14(b) shows a new target value calculated and motion of a lens.

FIG. 15 shows a result of simulation of OIS control in an elliptically enclosed portion of FIG. 14(a). FIG. 15(a) shows the angular displacement and motion of the image indicated by the motion signal, and FIG. 15(b) shows the new target value calculated and motion of the lens.

FIG. 16 illustrates a result of simulation of calculating a target value according to a comparative example. FIG. 16(a) shows angular displacement and motion of an image indicated by a motion signal. FIG. 16(b) shows a target value calculated and motion of a lens.

FIG. 17 illustrates a result of simulation of OIS control in an elliptically enclosed portion of FIG. 16(a). FIG. 17(a) shows the angular displacement and motion of the image indicated by the motion signal, and FIG. 17(b) shows the target value calculated and motion of the lens.

FIG. 18 illustrates a result of simulation of calculating a target value according to an embodiment. FIG. 18(a) shows angular displacement and motion of an image indicated by a motion signal. FIG. 18(b) shows a new target value calculated and motion of a lens.

FIG. 19 illustrates a result of simulation of OIS control in an elliptically enclosed portion of FIG. 18(a). FIG. 19(a) shows the angular displacement and motion of the image indicated by the motion signal, and FIG. 19(b) shows the new target value calculated and motion of the lens.

FIG. 20 illustrates a result of simulation of calculating a target value according to a comparative example. FIG. 20(a) shows angular displacement and motion of an image indicated by a motion signal. FIG. 20(b) shows a target value calculated and motion of a lens.

FIG. 21 illustrates a result of simulation of OIS control in an elliptically enclosed portion of FIG. 20(a). FIG. 21(a) shows the angular displacement and motion of the image indicated by the motion signal, and FIG. 21(b) shows the target value calculated and motion of the lens.

FIG. 22 illustrates a result of simulation of power consumption in OIS control according to an embodiment.

FIG. 23 illustrates a result of simulation of power consumption of OIS control according to a comparative example.

FIG. 24 illustrates a method of generating a new target value when the exposure period and the OIS control period do not match.

FIG. 25 illustrates a diagram showing a method for controlling optical image stabilization according to an embodiment.

FIG. 26 illustrates a diagram showing a method for controlling optical image stabilization according to an embodiment.

FIG. 27 illustrates a diagram showing a method for controlling optical image stabilization according to an embodiment.

FIG. 28 illustrates a diagram showing a method of generating a new target value according to an embodiment.

FIG. 29 illustrates a result of simulation of power consumption in OIS control according to an embodiment.

FIG. 30 illustrates a diagram showing a method of generating a new target value according to an embodiment.

### DESCRIPTION OF EMBODIMENTS

To make persons skilled in the art understand the technical solutions in the present disclosure better, the following clearly and completely describes the technical solutions in the embodiments of the present disclosure with reference to the accompanying drawings in the modes of the present disclosure. Apparently, the described embodiments are merely a part rather than all of the embodiments of the present disclosure. All other embodiments obtained by persons of ordinary skill in the art based on the embodiments of the present disclosure without creative efforts shall fall within the protection scope of the present disclosure.

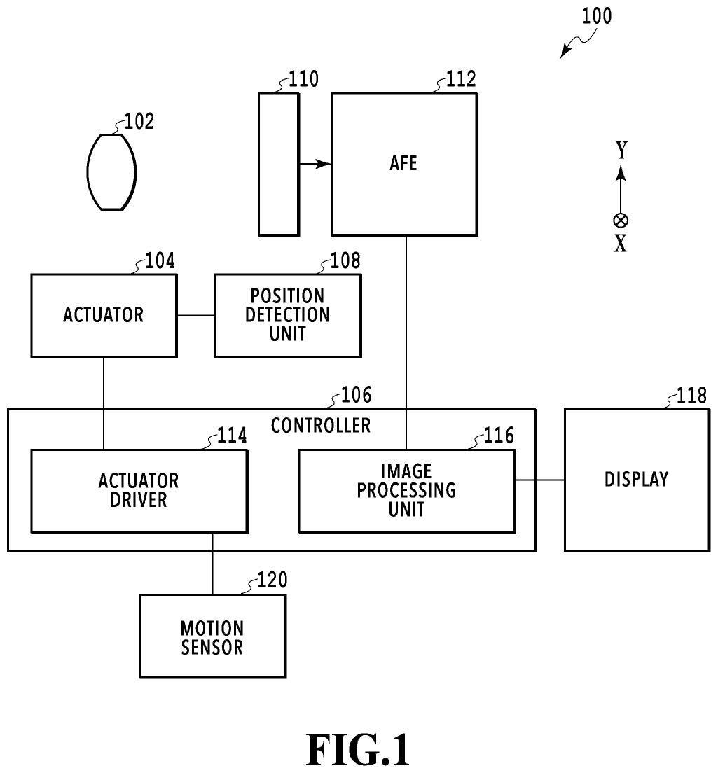

FIG. 1 is a diagram illustrating a basic configuration of an optical image stabilization system according to an embodiment of the present disclosure. Although the present embodiment describes an optical image stabilization that moves or rotates a camera module, the present disclosure can also be applied to a lens shift method that moves a lens and a sensor shift method that moves an image sensor.

The camera module 100 to which the optical image stabilization system is applied is mounted on an imaging device including a portable device such as a smartphone or tablet PC, or other camera. Although the camera module 100 may have blocks associated with other functions such as autofocus, FIG. 1 illustrates only blocks pertaining to the present embodiments to facilitate understanding of the present disclosure.

The camera module 100 is movably supported relative to a body of the imaging device. The camera module 100 is independently movable in the X-axis direction (a direction perpendicular to a paper plane) and the Y-axis direction (a longitudinal direction of the drawing), respectively. It should be noted that moving directions of the camera module 100 in this embodiment is only an example. For example, it can also be independently moved in the rotation (roll) direction around an optical center or a center of an imaging plane.

The camera module 100 includes an imaging lens 102, an image sensor 110, an actuator 104, a controller 106, a position detection unit 108, an AFE (Analog Front End) 112, a motion sensor 120, and a display 118.

The imaging lens 102 is provided on an incident light path of the image sensor 110 to direct the subject light to the image sensor 110.

The image sensor 110 is configured of an image sensor that photoelectrically converts a subject light and outputs a signal pertaining to a captured image. For example, the image sensor 110 may be a CMOS (Complementary Metal Oxide Semiconductor) sensor. The AFE 112 is configured to convert an analog signal output by the image sensor 110 into a digital signal and output it to the controller 106. The actuator 104 is configured to move the camera module 100. As described above, the camera module 100 can move independently in the X-axis direction and the Y-axis direction, and thus the actuator 104 controls motion independently in the X-axis direction and the Y-axis direction.

The motion sensor 120 is configured to detect motion of the camera module 100. For example, the motion sensor 120 may be a gyro sensor. The motion sensor 120 is configured to output a motion signal that indicates detected motion of the camera module 100.

The position detection unit 108 is for positioning the camera module 100. The position detection unit 108 may employ a magnetic detection element, such as a Hall sensor, for example. In this case, the magnetic detection element outputs a position detection signal indicating a displacement of the camera module 100.

The controller 106 has an actuator driver 114 and an image processing unit 116. The actuator driver 114 receives a motion signal from the motion sensor 120 and controls the actuator 104 to cancel motion of the camera module 100. The actuator driver 114 controls motion of the camera module 100 based on a motion signal from the motion sensor 120. For example, when a gyro sensor is used as the motion sensor 120, the motion signal indicates an angular velocity in the yaw direction (a direction perpendicular to the paper plane) and an angular velocity in the pitch direction (a longitudinal direction of the drawing). The actuator driver 114 calculates the displacement of the angle by integrating the motion signal for the yaw direction and the pitch direction, respectively. The actuator driver 114 then displaces the camera module 100 in response to the desired angular displacement. In this manner, the actuator driver 114 outputs the drive signal and performs feedback control such that the position of the camera module 100 indicating the position detection signal moves to a target position in response to motion of the camera module 100. The actuator 104 performs drive control of the camera module 100 based on the drive signal from the actuator driver 114. It should be noted that directions of actuation by the actuator driver 114 in this embodiment is just an example. For example, it is also possible to independently drive in the rotation (roll) direction around an optical center or a center of an imaging plane.

The image processing unit 116 is configured to execute a predetermined process on the signal output by the AFE 112 and outputs the image signal. The display 118 is configured to display an image based on an image signal received from the image processing unit 116. For example, the display 118 may be a LCD (Liquid Crystal Display).

Although an optical image stabilization system is applied to the camera module 100 as shown in FIG. 1 in the present embodiment, the camera module 100 may be adaptively designed in accordance with the compensation target object. For example, if the optical image stabilization system of the present disclosure is applied to the lens shift method, the imaging lens 102 is movably supported in the yaw direction and the pitch direction. The position detection unit 108 detects the position of the imaging lens 102, and the motion sensor 120 detects motion of the imaging lens 102. Also, when the optical image stabilization system of the present disclosure is applied to the sensor shift method, the image sensor 110 is movably supported in the yaw direction and the pitch direction. The position detection unit 108 detects the position of the image sensor 110, and the motion sensor 120 detects motion of the image sensor 110.

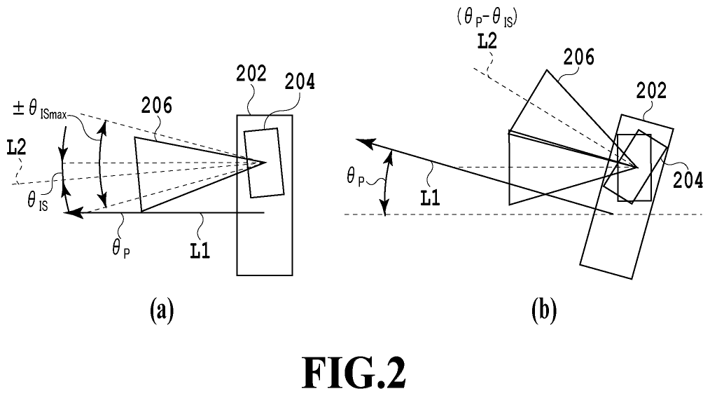

Referring now to FIGS. 2 to 5, a general method of optical image stabilization of the module tilt type OIS will be described. In the following description, although the optical image stabilization in the pitch direction of the smartphone and camera module will be described, the optical image stabilization in the yaw direction can be performed in the same manner.

FIG. 2 illustrates, by way of example, motion of the smartphone 202 and the camera module 204. In FIG. 2, the smartphone 202 is in a reference position and the axis L1 perpendicular to one face of the body of the smartphone 202 is oriented horizontally. Op indicates the angular displacement of the smartphone 202 in space from the reference position of the body. θ_{IS} indicates a swing angle of the camera module 204 relative to the body of the smartphone 202, which is the swing angle of the optical axis L2 of the imaging lens 102. When the camera module 204 is in the reference position, the optical axis L2 is parallel to the axis L1. θ_{ISmax} indicates the maximum value of θ_{IS}. θ_{ISmax} is determined by the mechanical limitation of the camera module 204. For example, the angle of the upward facing arrow may be 20 degrees from the reference position, and the angle of the downward facing arrow may be −20 degrees.

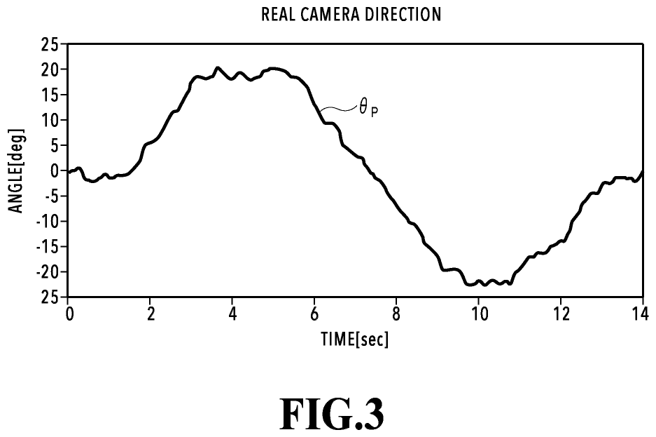

In the example shown in FIG. 2(a), the angular displacement θ_{P} of the body of the smartphone 202 is 0°. The camera module 204 can rotate in a range of ±θ_{ISmax}. If θ_{ISmax}=20°, the smartphone 202 can start at 0°, move between approximately ±20° and −20°, and vibrate in small increments due to camera shake. The triangle 206 indicates the movable range of the camera module 204. As the camera module 204 moves in the pitch direction, the movable range moves correspondingly. The smartphone 202 obtains the angular displacement θ_{P} shown in FIG. 2(b) as a signal of a stabilization trajectory based on a signal from the motion sensor 120 and the like. The movable range of the camera module 204 may vary as shown in the triangle 206. FIG. 3 is an example of a graph showing values of the obtained angular displacement θ_{P}, with the vertical axis showing the angular displacement (degrees) and the horizontal axis showing the time (sec).

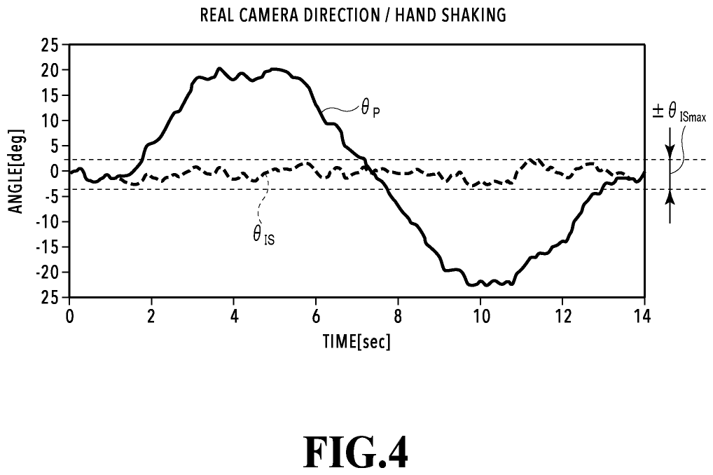

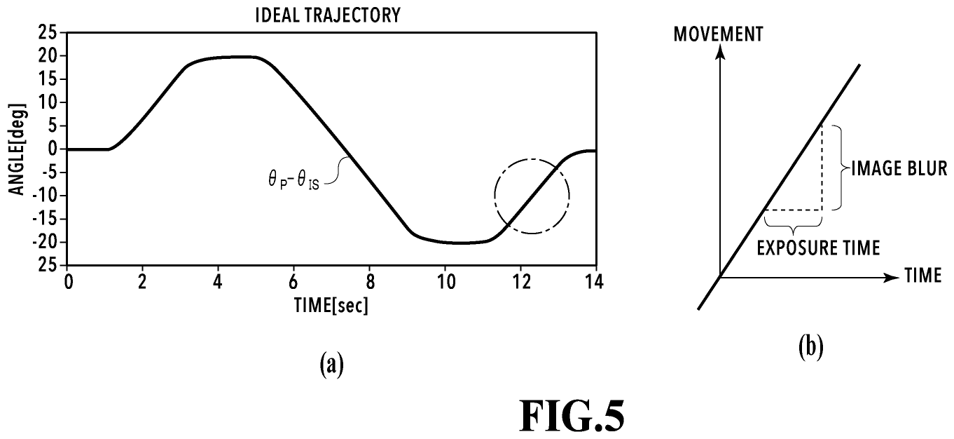

In the optical image stabilization, the angle θ_{IS} of the camera module 204 is calculated by some calculation algorithm such as a calculation algorithm based on output values from the gyro sensor, so as to remove the small change included in the angular displacement θ_{P}, as shown in FIG. 4. Because there is a mechanical limitation to the motion of the camera module 204, the angle θ_{IS} is calculated in the range of ±θ_{ISmax}. FIG. 5 is a graph showing the value of θ_{P}−θ_{IS}. The smartphone 202 may move the camera module 204 based on the value of θ_{IS}. According to the conventional ideal θ_{IS} algorithm, the result is a smooth image trajectory in space, as in θ_{P}−θ_{IS} of FIG. 5(a).

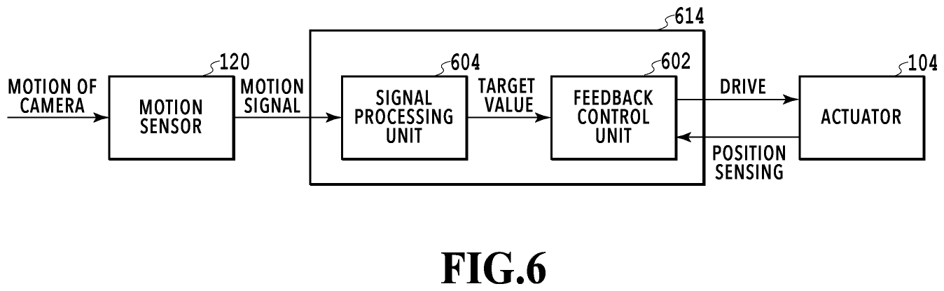

FIG. 6 illustrates an example of a functional block involving a conventional OIS method. The actuator driver 614 includes a signal processing unit 604 and a feedback control unit 602. The motion sensor 120 detects motion of the camera module 100 and outputs a motion signal. This motion signal may be a signal indicating an angular velocity or an acceleration. The signal processing unit 604 calculates an angle θ_{IS} of the camera module 204 such that the minute change included in the angular displacement θ_{P} is removed based on the value of the motion signal, within the mechanical limitation. This value is a target value, which is provided from the signal processing unit 604 to the feedback control unit 602. The feedback control unit 602 sends a drive signal to the actuator 104 based on the received target value. The actuator 104 controls the position of the camera module 100 based on the received drive signal. The position of the camera module 100 is detected by the position detection unit 108. The new position information is used in the feedback control unit 602 to generate a new drive signal. The Target Value indicates a target value for an amount of operation of the actuator 104 held in the feedback control unit 602. The signal processing unit 604 generates the Target Value based on the movement of the camera module 204. In any configuration of the θ_{IS}, the signal processing unit 604 may be disposed before the signal indicating the Target Value, and the feedback control unit 602 may be disposed after the Target Value as shown in FIG. 6. However, the signal processing unit 604 and the feedback control unit 602 are functional configurations of the actuator driver 114 and do not necessarily coincide with the physical configuration.

The signal processing unit 604 may also be configured to make a determination of the pan-tilt state based on a position detection signal received from the position detection unit 108. In addition, the signal processing unit 604 may output other signals such as a determination result of the pan-tilt state.

In the conventional θ_{IS}, there are two problems:

First, since feedback control is employed in the conventional θ_{IS}, the stabilization process must be carried out in real time. In other words, the method of storing the imaging data and information from the motion sensor in a memory and deriving the optimal angle θ_{IS} later cannot be used. Under such condition, it is necessary to calculate angle θ_{IS} that does not exceed θ_{ISmax} without delay. Since it is impossible to accurately predict the future, even if the angle θ_{IS} does not reach θ_{ISmax}, it is necessary to limit the operation of OIS from a little before θ_{ISmax}. As a result, even if the OIS is operating within the range of +θ_{ISmax}, the performance of the OIS is not fully demonstrated.

Second, suppose that an ideal angle θ_{IS} as shown in FIG. 4 can be derived, and that a smooth displacement of the image in space can be realized by OIS as shown in FIG. 5(a). In this case, image blur can be suppressed by OIS at 0 sec to 1 sec, 3 sec to 5 sec, and 9 sec to 11 sec. However, the imaging device is in the pan-tilt state from 1 sec to 3 sec, from 5 sec to 9 sec, and from 11 sec to 13 sec. If the exposure period is extended in the punch-tilt state, blurring of the image during that exposure period cannot be suppressed. FIG. 5(b) is an enlarged view of the circled portion in FIG. 5(a) and shows the change in angle (degrees) from 11 sec to 13 sec. In the case where the exposure period is included in this period, the image stabilization fails, and image blur occurs. In other words, as long as OIS uses the conventional algorithm, it is not possible to suppress image blurring in the pan-tilt state. This means that the image quality is deteriorated when a photographer performs a panning operation upon photographing a moving image and the OIS system is in the pan-tilt state.

### First Embodiment

In this embodiment of the present disclosure, it is possible to effectively suppress blur of an image and improve the quality of the video in the pan-tilt state in which it was fundamentally impossible to stop image blurring in the conventional OIS that continuously drives the compensation target object.

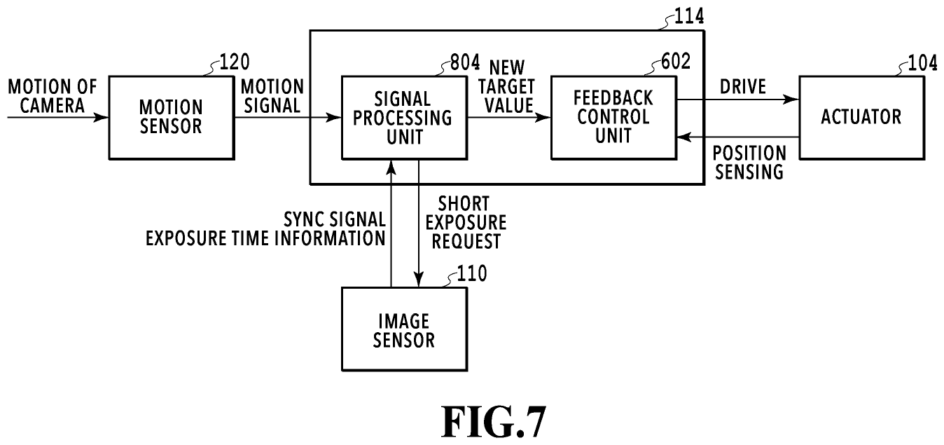

Referring now to FIG. 7, an example of a functional block diagram pertaining to the OIS according to the present embodiment will be described. The actuator driver 114 includes a signal processing unit 804 and a feedback control unit 602. The motion sensor 120 detects motion of the camera module 204 and outputs a motion signal. The signal processing unit 804 calculates the angle θ_{IS} of the camera module 204 such that the minute change included in the angular displacement θ_{P} is removed based on the value of the motion signal. This value is a target value, which is provided by the signal processing unit 802 to the feedback control unit 602. The feedback control unit 602 sends the drive signal to the actuator 104 based on the received target value. The actuator 104 controls the position of the camera module 100 based on the received drive signal. The position of the camera module 100 is detected by the position detection unit 108. The new position information is used in the feedback control unit 602 to generate the new drive signal.

The signal processing unit 804 may communicate with the image sensor 110. That is, the signal processing unit 804 is configured to send a signal to the image sensor 110 to request a shorter exposure period. The image sensor 110 also sends a synchronization signal to the signal processing unit 804 for synchronizing the timing of each frame to the signal processing unit 804.

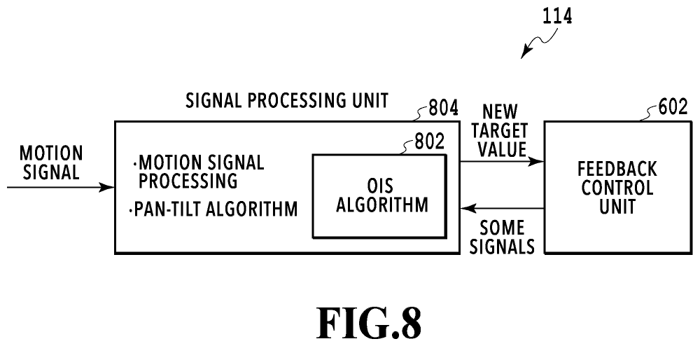

FIG. 8 illustrates more detailed communication between the signal processing unit 804 and the feedback control unit 602. Here, a New Target Value means a new target value for the operating amount of the actuator 104, held in the feedback control unit 602. The signal processing unit 604 generates the New Target Value based on the movement of the camera module. As can be understood from the comparison of FIGS. 6 and 8, the functions related to the OIS according to the present embodiment can be realized by adding new functions to the signal processing unit, and conventional components can be used for other components of the camera module 100. Accordingly, a detailed description of the other components will be omitted.

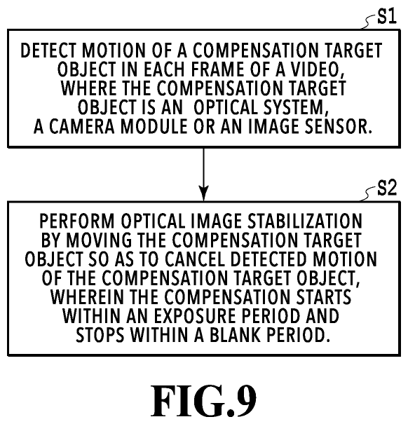

Next, a method for deriving a target value according to the present embodiment will be described with reference to the flowchart in FIG. 9.

In operation S1, motion of the compensation target object is detected in each frame of the moving image. In the present embodiment, the compensation target object is a camera module. The compensation target object may be an optical system such as lens, a camera module, or an image sensor.

In operation S2, the compensation target object is moved so as to cancel the motion of the detected compensation target object, and the image blur is compensated. Here, the period corresponding to each frame includes an exposure period in which exposure is carried out and a blank period in which exposure is suspended. In the image blur compensation, the compensation is started such that the compensation is carried out in at least a portion of the exposure period, and the compensation is suspended such that the compensation is not carried out in at least a portion of the blank period.

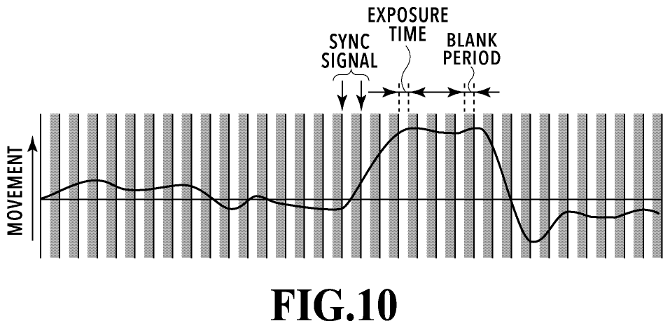

FIG. 10 is a graph showing displacement of a camera module, with a vertical axis indicating angular displacement of the camera module and a horizontal axis indicating time. As shown in FIG. 10, the period of one frame when photographing a moving image is composed of the exposure period and the blank period. The duration of the frame is synchronized by a synchronization signal. Here, the synchronization signal is a signal supplied from the image sensor at the beginning of the frame. A white part in the figure indicates the exposure period, and a gray part indicates the blank period. The synchronization signal does not necessarily need to match the beginning of the exposure period. If the timing of the exposure period can be derived based on the synchronizing signal output from the image sensor, it can be used for the optical image stabilization in this embodiment.

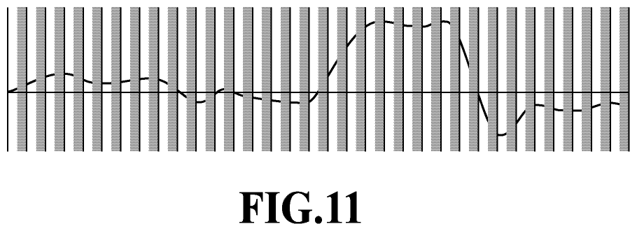

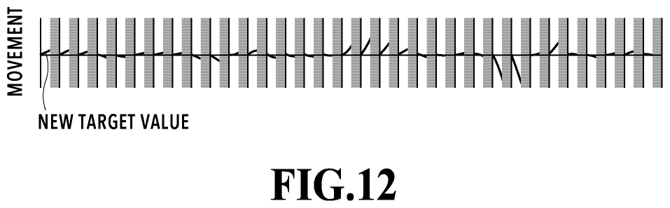

In the algorithm of this embodiment, the signal processing unit 804 may receive a continuous motion signal as shown in FIG. 10, similar to the conventional OIS. In the present embodiment, the new target value specialized in suppressing image blur during the exposure period is generated. During the blanking period, the feedback control system including the feedback control unit 602 and the actuator 104 need not follow the motion signal. That is, as shown in FIG. 11, only the portion of the motion signal during the exposure period is used for the OIS control. The fragmented target value shown in FIG. 11 includes an offset (DC (Direct Current) component) from the reference position at the start position of the exposure period. Due to the nature of the θ_{IS}, it need not align the position of the compensation target object indicated by the Target Value with the position of the compensation target object operated by the actuator 104. The OIS is available if the speed of displacement of the compensation target object indicated by the Target Value can be matched with the speed of the compensation target object operated by the actuator 104. Accordingly, the DC component can be removed from the Target Value, leaving only the information of the speed of the compensation target object, and moved parallel to the proximity of the origin, as shown in FIG. 12. In this way, the target value moved parallel is taken as the new target value. During the blank period, the compensation target object may be moved to a convenient position at the start of the next frame during the blank period, since the object is not exposed. In this way, the compensation target object is moved so as to maximize an operable range of the compensation target object in the blank period based on motion of the compensation target object detected in the previous OIS control period. This is the outline of the algorithm for calculating the target value according to the present embodiment.

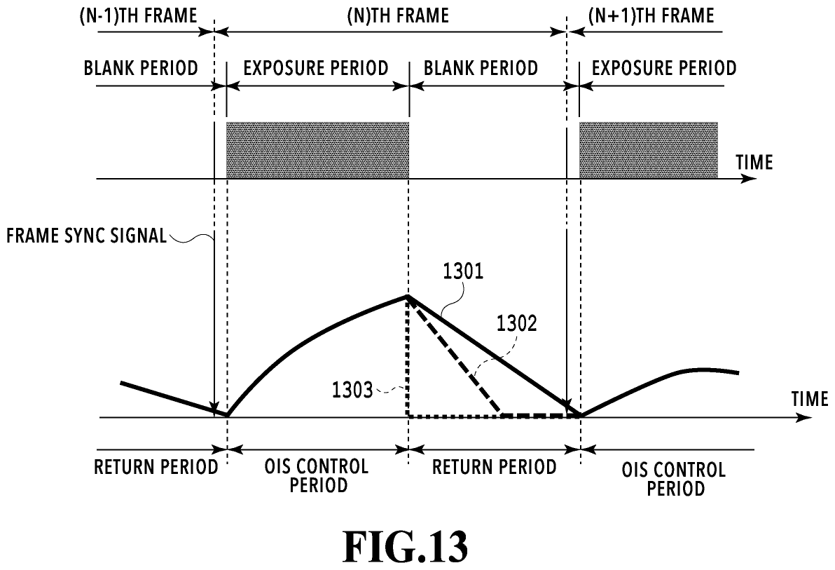

Next, a method for generating the new target value according to the present embodiment will be described with reference to FIG. 13.

FIG. 13 illustrates the relationship among an exposure period, a blank period, a frame synchronization signal, an OIS control period, and a return period which is a period returning to the reference position for each frame during photographing of a moving image. FIG. 13 illustrates the N^{th} frame and a portion of the frame before and after it, with the vertical axis indicating displacement of the camera module 100 and the horizontal axis indicating time. Each frame includes the exposure period and the blank period that does not expose. The start time of each frame coincides with the timing at which the signal processing unit 802 receives the frame synchronization signal.

The OIS control period is calculated based on the synchronization signal from the image sensor, the specification of the image sensor, or the exposure information.

The exposure period is initiated by the signal processing unit 802 with a slight delay in receiving the frame synchronization signal. The position of the camera module 100 is the reference position (zero position) at the beginning of the exposure period and gradually increases over time. The signal processing unit 802 generates a target value for moving the camera module 100 so as to cancel the displacement of the camera module 100.

When the exposure period ends, the OIS control period ends. The signal processing unit 802 generates the target value for moving the camera module 100 to the reference position between the start and end of the blank period. The solid line 1301 indicates the displacement of the camera module 100 when the camera module 100 is moved to the reference position at a constant speed between the start and end of the blank period. The dashed line 1303 indicates the displacement of the camera module 100 when moving the camera module 100 rapidly with the start of the blank period. The dashed line 1302 indicates the displacement of the camera module 100 when moving the camera module 100 at a constant speed such that the camera module 100 returns to the reference position during the blank period.

The new target value of the period for returning to the reference position may be determined in view of the length of time and the power consumption of the period for returning to the reference position.

In the case where the frame length is constant, the OIS control period becomes longer when the exposure period becomes longer. Because the blank period is relatively short, the duration for the camera module 100 to return to the reference position is shortened. In this case, it is preferable to quickly return the camera module 100 to the reference position and set the target value such that the camera module 100 is moved as indicated by the dashed line 1303.

If the exposure period is short and the duration for which the camera module 100 can return to the reference position is long, the target value may be set such that the camera module 100 moves slowly. In this case, power consumption can be reduced.

Further, if the camera module 100 balances the speed and power consumption of returning to the reference position, the target value may be generated for the camera module 100 to move as indicated by the dashed line 1302.

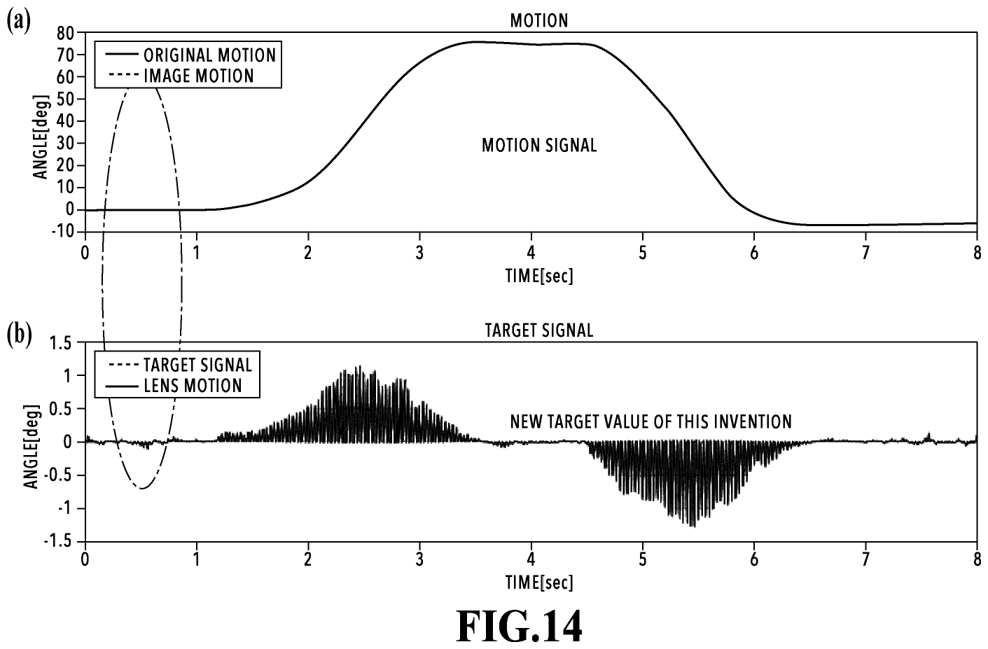

FIG. 14 to FIG. 23 show the result of simulation of target values according to the present embodiment and a comparative example. In all these drawings, curves of the same motion signal are used.

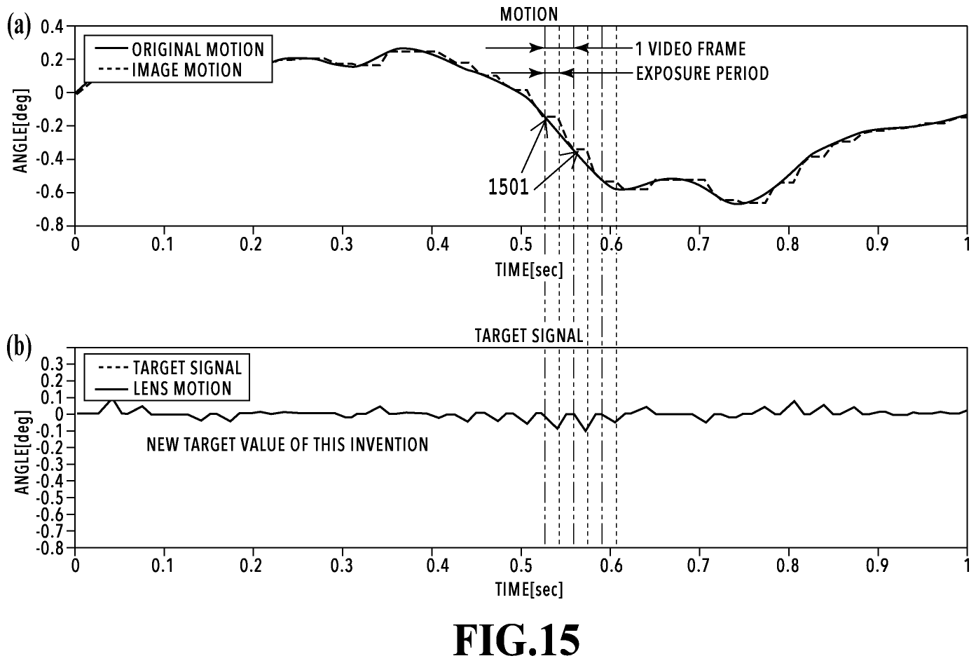

FIG. 14 shows a result of simulation of calculating the target value according to the present embodiment. FIG. 14(a) shows the angular displacement indicated by the motion signal and motion of an image. FIG. 14(b) illustrates the new target value calculated and motion of a lens while the camera module is moving, as shown in FIG. 14(a). The portion enclosed by an ellipse indicates a state before transitioning to the pan-tilt state. FIG. 15 shows the result of the simulation of the OIS control in the elliptical-enclosed portion of FIG. 14(a). A solid curve of FIG. 15(a) shows values of camera shake signals detected from the original motion of the camera module, and a dashed curve indicates the motion of an image after the optical image stabilization according to the embodiment. The solid curve in FIG. 15(b) indicates the motion of the lens accompanying the motion of the camera module, and the dashed curve in FIG. 15(b) shows the target value calculated in the corresponding period. In the dashed curve of FIG. 15(a), the reference numeral 1501 indicates the exposure period. The image does not move during the exposure period because the OIS control is effectively carried out. Accordingly, when the image generated during the exposure period is displayed on the display during the period of each frame, a stable image without blur may be displayed.

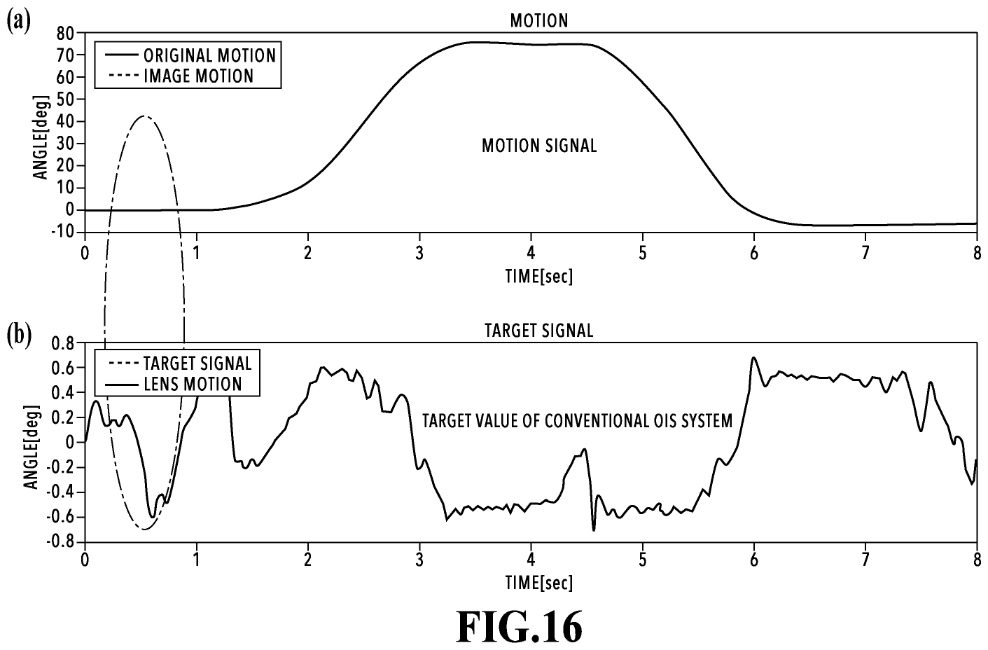

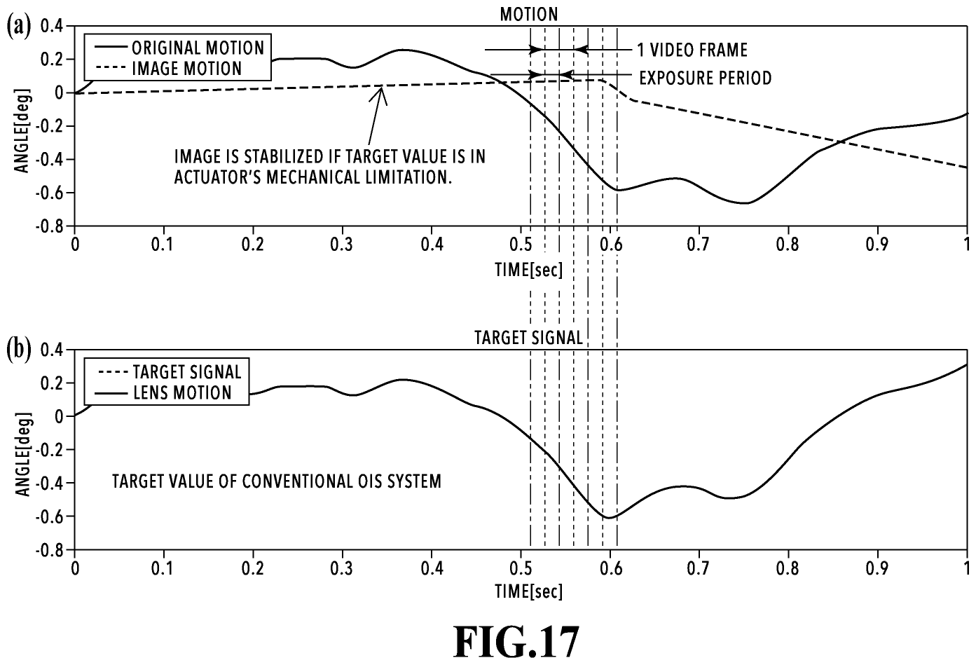

FIG. 16 shows the result of simulation of calculation of a target value using a conventional method for calculating a target value as a comparative example. The target value is calculated using a continuous motion signal as shown in FIG. 10. FIG. 16(a) shows the angular displacement indicated by the motion signal and motion of the image, and FIG. 16(b) shows the calculated target value and motion of the lens. FIG. 17 shows the result of simulation of the OIS control in the portion surrounded by an ellipse in FIG. 16(a). In the area enclosed by the ellipse, the actuator moves within the range of the mechanical limitation. Therefore, the image is substantially still as shown in FIG. 17(a), and motion of the lens is effectively controlled as shown in FIG. 17(b).

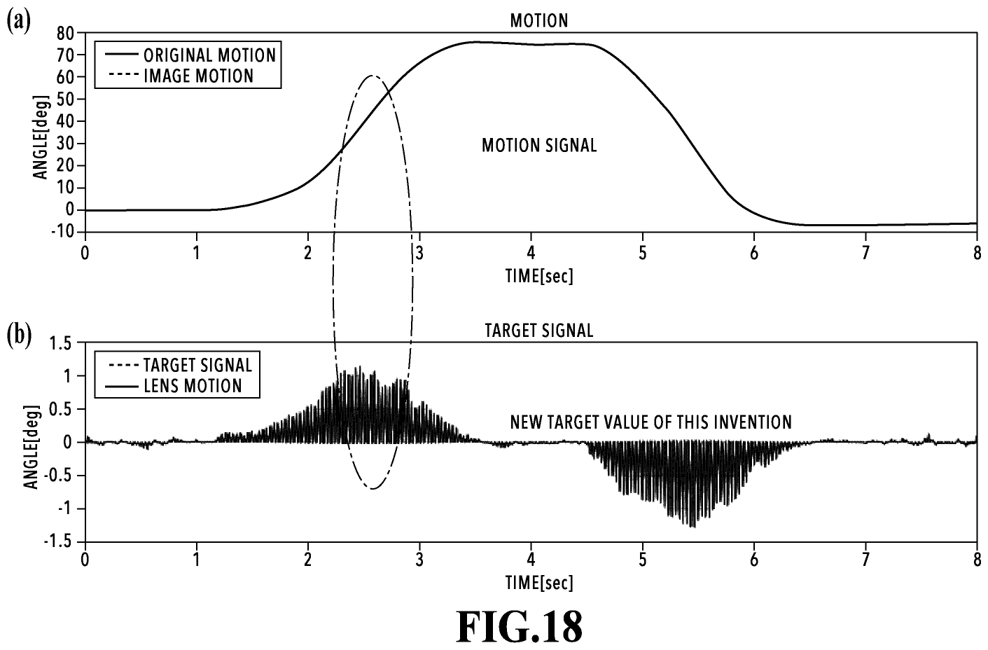

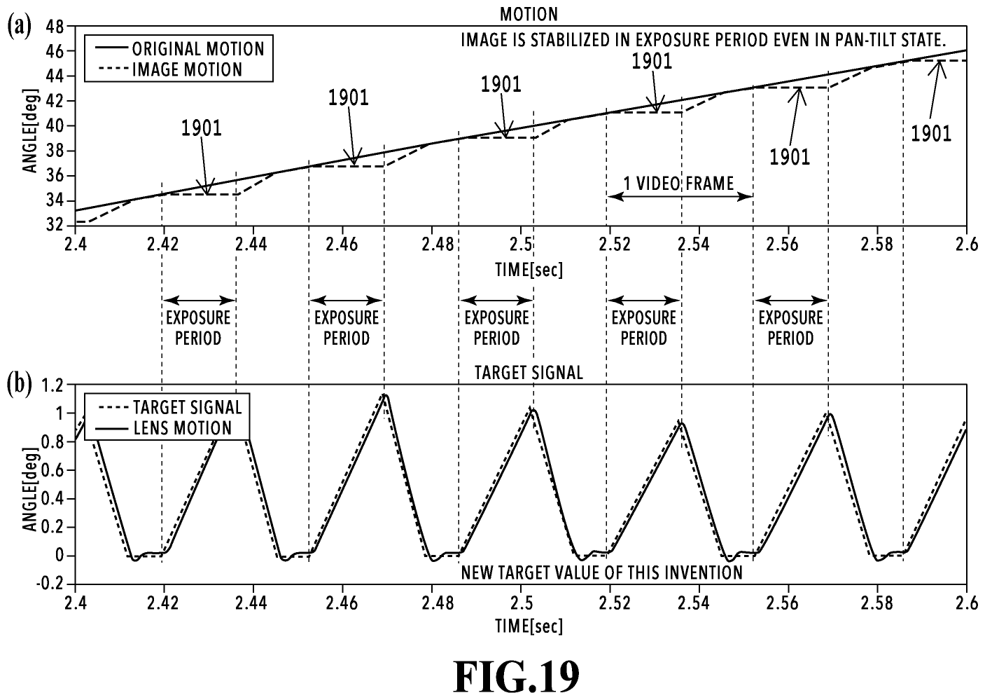

FIG. 18 shows the result of simulation of calculation of the target value according to the present embodiment. FIG. 18(a) shows the angular displacement indicated by the motion signal and motion of the image, and FIG. 18(b) shows the calculated target value and motion of the lens. In the portion surrounded by the ellipse, the imaging device shifts to the pan-tilt state. FIG. 19 shows the result of simulation of the OIS control in the portion surrounded by an ellipse in FIG. 18(a). A solid curve in FIG. 19(a) indicates a camera shake signal detected from the original motion of the camera module, and a dashed curve indicates motion of the image after the optical image stabilization according to the present embodiment. The solid curve in FIG. 19(b) indicates motion of the lens in accordance with motion of the camera module, and the dashed curve indicates the target value calculated in the corresponding period. In the dashed curve in FIG. 19(a), the reference numeral 1901 indicates the exposure period. Since the OIS control is effectively performed during the exposure period, the image does not move. Therefore, a stable image without blurring can be displayed in the pan-tilt state.

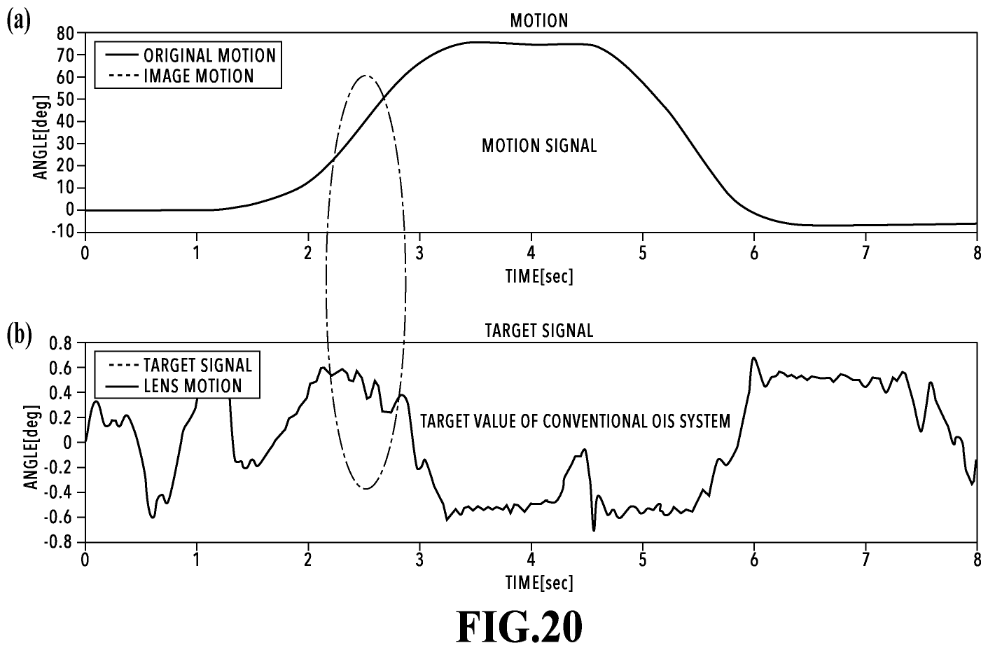

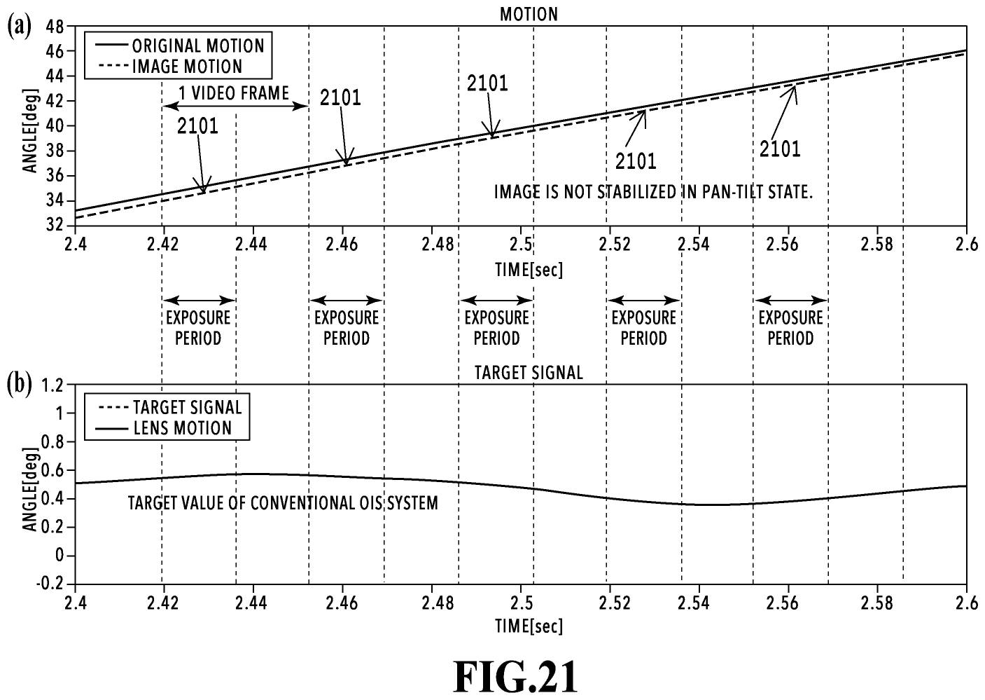

FIG. 20 shows the result of simulation of calculation of the target value using the conventional method for calculating the target value as the comparative example. FIG. 20(a) shows the angular displacement indicated by the motion signal and motion of the image. FIG. 20(b) shows the calculated target value and motion of the lens. FIG. 21 shows the result of simulation of the OIS control in the portion surrounded by an ellipse in FIG. 20(a). In the elliptical area, control of motion of the actuator exceeds the mechanical limitation. During the exposure period indicated by reference numeral 2101 in FIG. 21(a), the image continues to move, and the motion of the lens is almost stopped as shown in FIG. 21(b).

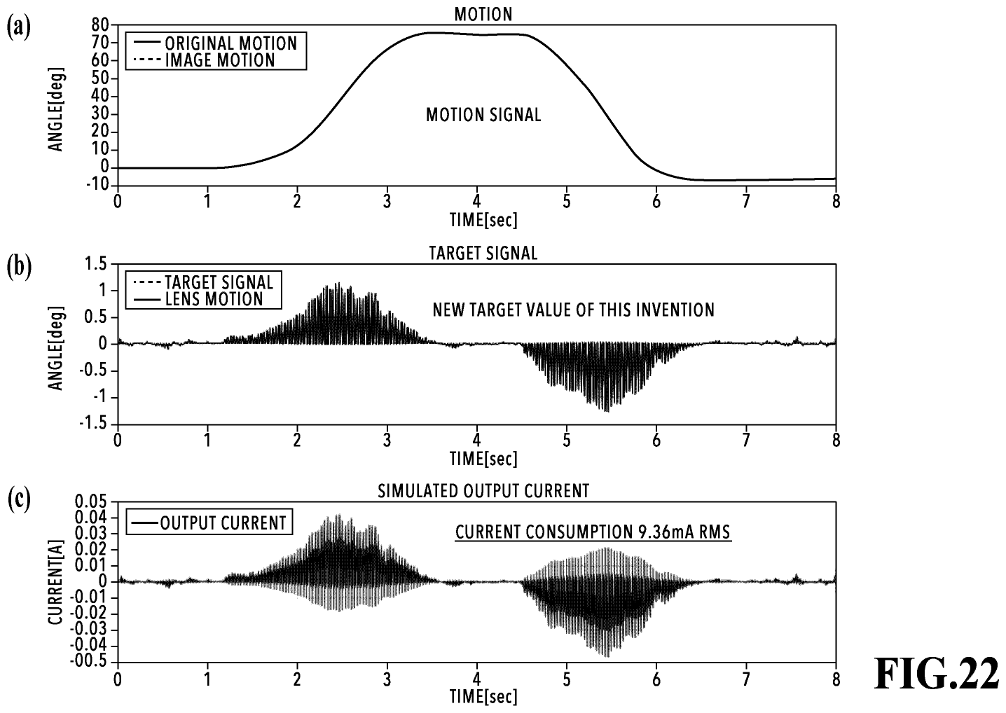

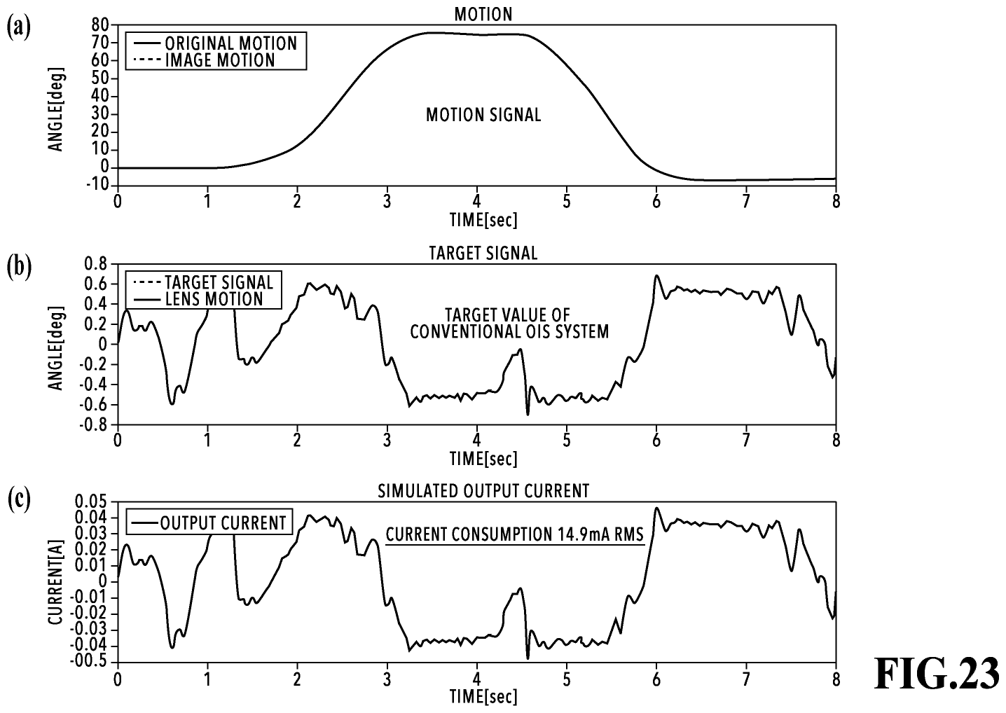

FIG. 22 shows the result of simulation of power consumption of the OIS control according to the present embodiment. FIG. 22(a) shows the angular displacement indicated by the motion signal and motion of the image, FIG. 22(b) shows the calculated new target value and motion of the lens, and FIG. 22(c) shows the result of the simulation of the power consumption. In the OIS control in this simulation, as indicated by the reference numeral 1302 in FIG. 13, control is adopted to move the camera module 100 at a constant speed so that the camera module 100 returns to the reference position during the blank period. Also, FIG. 23 shows the result of simulation of the power consumption in the OIS control according to the comparative example. FIG. 23(a) shows the angular displacement indicated by the motion signal and motion of the image, FIG. 23(b) shows the calculated target value and motion of the lens, and FIG. 23(c) shows the result of simulation of the power consumption. The effective current value of the OIS control according to the present embodiment was 9.36 mARMS, while the effective current value of the OIS control according to the comparative example was 14.9 mARMS. Therefore, it can be understood that the power consumption can be reduced according to the present embodiment.

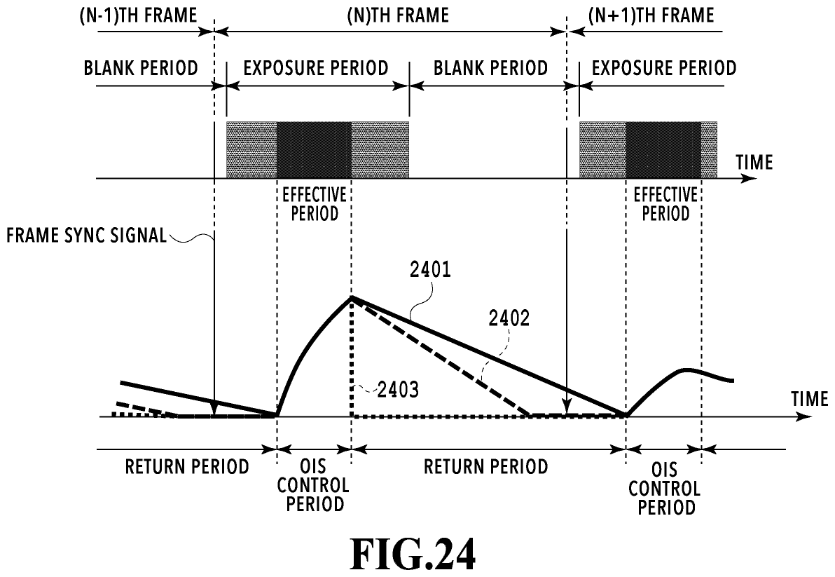

FIG. 24 illustrates a case where the exposure period and the OIS control period do not match. Depending on the application, the OIS control may not be required in all areas of the image sensor. In such a case, the OIS control may be carried out only in the necessary time domain. In the example shown in FIG. 24, the OIS control period is set to an effective period of the exposure period. The solid line 2401 indicates the displacement of the camera module 100 when moving the camera module 100 to the reference position at a constant speed between the end of the effective period and the start of the next effective period. The dashed line 2403 indicates the displacement of the camera module 100 when the camera module 100 is moved rapidly. The dashed line 2402 indicates the displacement of the camera module 100 when moving the camera module 100 at a constant speed such that the camera module 100 returns to the reference position during the blank period.

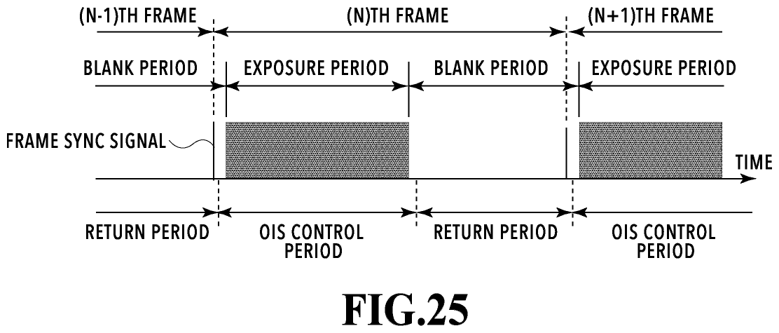

In addition, the response of the feedback control unit 602 may be disturbed immediately after the start or end of the OIS control period. Accordingly, the start of the exposure period and the start of the OIS control period may be different. Furthermore, the end of the exposure period and the end of the OIS control period may be different. Accordingly, the optical image stabilization may be configured to start so as to perform the optical image stabilization in at least a portion of the exposure period (the first period) and to stop so as not to perform the optical image stabilization in at least a portion of the blank period (the second period). FIGS. 25 to 27 illustrate some examples of methods of controlling such optical image stabilization.

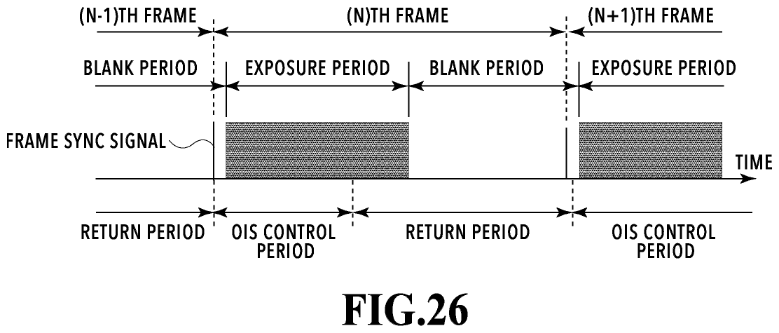

In the example shown in FIG. 26, the OIS control period begins between the start time of the N^{th} frame and the start time of the exposure period, and the OIS control period ends immediately after the end of the exposure period. The remainder of the frame period may be set as a return period for moving the camera module 100 to the reference position.

In the example shown in FIG. 26, the OIS control period begins between the start time of the N^{th} frame and the start time of the exposure period, and the OIS control period ends in the middle of the exposure period.

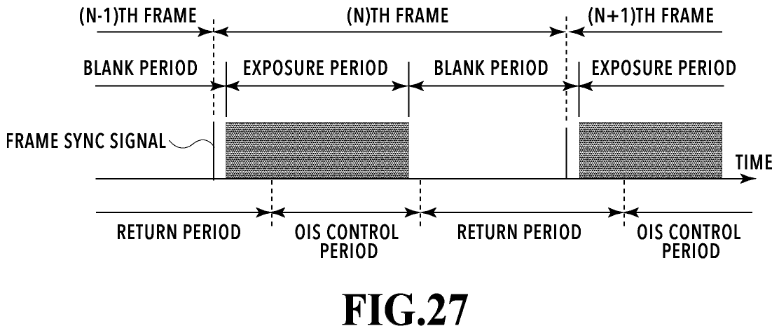

In the example shown in FIG. 27, the OIS control period begins after the start of the exposure period, and the OIS control period ends immediately after the end of the exposure period.

In any of the examples illustrated in FIGS. 25 to 27, providing a period during which the OIS control is carried out during the exposure period in each frame and a period during which the OIS control is not carried out during the blank period makes it possible to suppress image blur in the pan-tilt state and improve the quality of the moving image.

### Second Embodiment

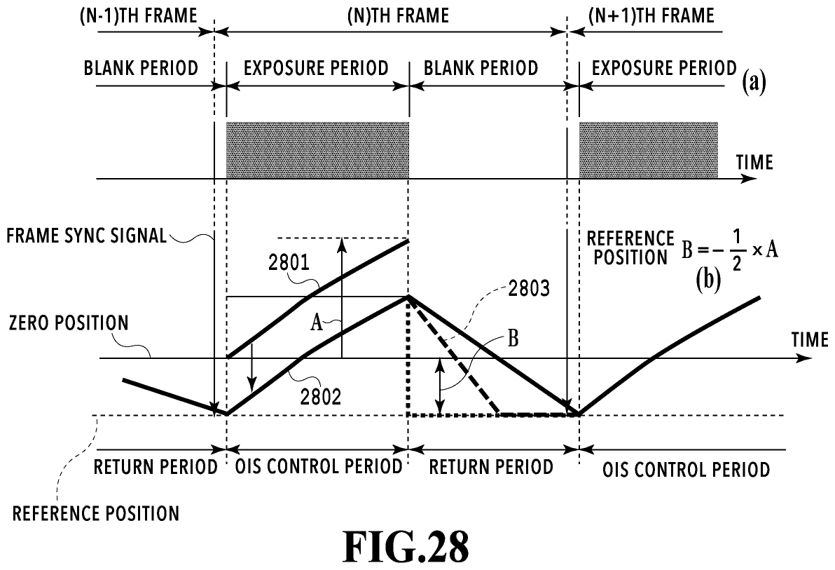

Next, the second embodiment of the present disclosure will be described in which the reference position of the camera module 100 is set adaptively. Typically, the reference position is set to a position (zero position) where the mechanical center or optical center of the actuator 104 is at the center of the image sensor. Here, the mechanical center of the actuator 104 is an example of the center of a mechanism for moving the compensation target object. Also, the optical center of the actuator 104 is an example of optical center of the compensation target object. In FIGS. 13 and 24, the reference positions are set according to this convention. According to the method for setting the reference position, the DC component of the displacement of the camera module has been removed, and thus a sufficient reduction in power consumption can be expected compared to the conventional OIS method. In order to further reduce power consumption, the reference position may be set as shown in FIG. 28. In the example illustrated in FIG. 28, the reference position is set such that the amplitude of the camera module 100 spans the zero position and amplitudes are approximately equal in both positive and negative directions. A method for calculating the target value according to the present embodiment will be described. The displacement amount during the OIS control period in a certain frame is taken as A. The reference position within the same frame may be calculated by B=−A/2, taking the displacement from the original reference position (zero position) as B. The signal processing unit 802 generates the target value to move the position of the camera module 100 to the reference position B determined by this formula. By setting the target value in this way, the target value moves from the curve 2801 to the curve 2802. In this manner, during the blank period, a process for moving the compensation target object so as to maximize the operational range of the compensation target object is carried out based on the movement of the compensation target object detected in the previous OIS control period. Also, since the amplitude from the zero position is approximately halved, further reduction in power consumption is achieved.

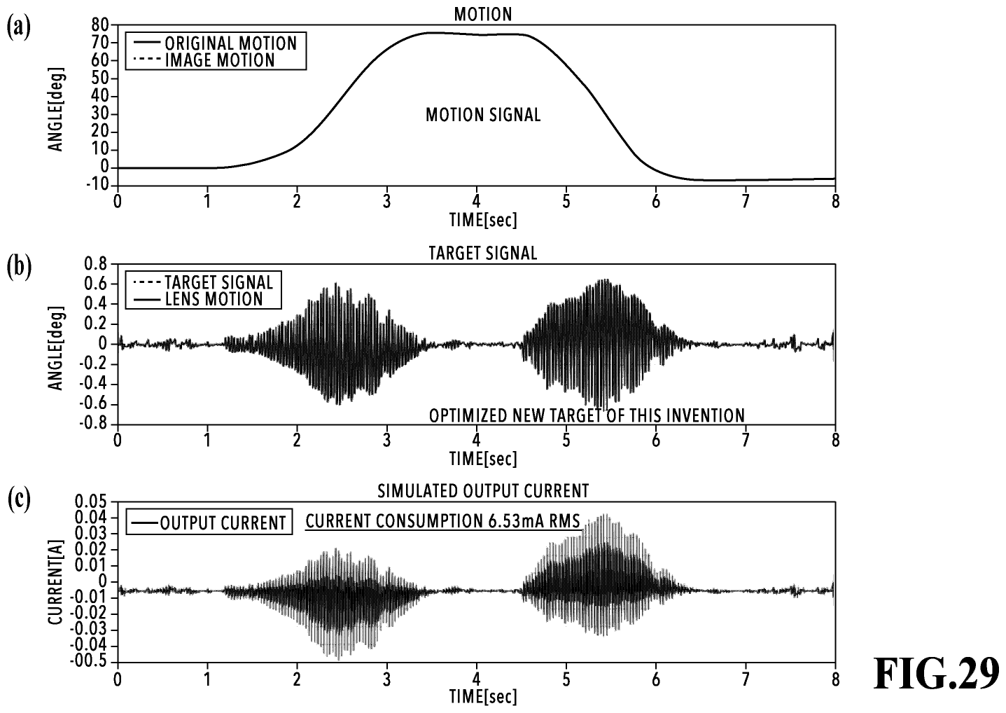

FIG. 29 shows the result of simulation of power consumption of the OIS control according to the present embodiment. FIG. 29(a) shows the angular displacement indicated by the motion signal and motion of the image, FIG. 29(b) shows the calculated new target value and motion of the lens, and FIG. 29(c) shows the result of simulation of the power consumption. In the OIS control in this simulation, as indicated by the reference numeral 2802 in FIG. 28, control is adopted to move the camera module 100 at a constant speed so that the camera module 100 returns to the reference position during the blank period. The effective current value of the OIS control according to the present embodiment was 6.53 mARMS. Therefore, it can be understood that the power consumption can be further reduced according to the present embodiment.

### Third Embodiment

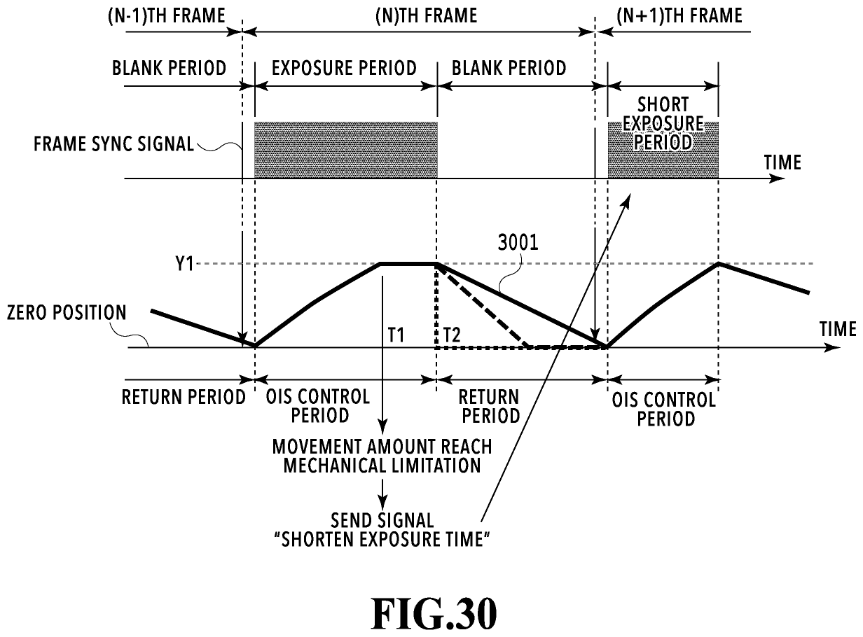

Next, the third embodiment of the present disclosure will be described with reference to FIG. 30.

If the compensation target object reaches the limit of the operable range of the actuator during the OIS control period, movement of the camera module 100 is suspended. As indicated by a solid line 3001, the camera module 100 reaches the maximum value Y1 of the operating range of the actuator at time T1, and movement stops until the end time T2 of the OIS control period.

At this time, the signal processing unit 802 sends a request signal to the feedback control unit 602 to shorten the exposure period from the next frame. The feedback control unit 602 shortens the exposure period after the next frame based on the received request signal. The (N±1)^{th} frame has a shorter exposure period compared to the N^{th} frame. By controlling the OIS control period in this way, it is possible to avoid the compensation target object reaching the limit of the operable range of the actuator, or to shorten the time for which the OIS control becomes impossible. Therefore, it is possible to reduce the period in which the effect of stabilization is impaired.

The present embodiment may be combined with the second embodiment as described above. In this case, the signal processing unit 804 sets the reference position such that the amplitude of the camera module 100 spans the zero position and the amplitudes are approximately equal in both positive and negative directions. In this case, the predicted operating range of the compensation target object may fall within the operable range of the actuator 104.

The algorithm for deriving the target value according to the present disclosure is applicable to an optical image stabilization system of any product and is not limited by physical embodiments.

The target value of the compensation target object according to the above-described embodiment may be repeatedly set in synchronization with the frame rate of the moving image. In other words, the operation for setting the new target value and moving the compensation target object is a cyclical operation of 60 Hz for a 30 fps video and 60 fps for a 30 Hz or 60 fps video. Therefore, it is desirable that a transfer function from the Target Value in FIG. 7 to the output of the displacement by the actuator has a flat frequency characteristic that can adequately handle the frame rate of the desired moving image.

The above embodiments can be applied to all optical devices capable of using optical image stabilization. For example, the above embodiments can be applied to a smartphone built-in camera, a tablet built-in camera, an action camera, a lens interchangeable camera, a surveillance camera, an in-vehicle camera, an aircraft mounted camera, and the like.

The foregoing descriptions are merely specific implementation manners of the present disclosure, but are not intended to limit the protection scope of the present disclosure. Any variation or replacement readily figured out by a person skilled in the art within the technical scope disclosed shall fall within the protection scope of the present disclosure. Therefore, the protection scope of the present disclosure shall be subject to the protection scope of the claims.

What is claimed is:

1. An optical image stabilization system, comprising:
a detection unit configured to detect motion of a compensation target object in each frame of a moving image, wherein the compensation target object is an optical system, a camera module or an image sensor; and
a driver configured to perform a compensation of a blur of an image by moving the compensation target object so as to cancel the motion of a detected compensation target object,
wherein a period corresponding to each frame includes a first period during which an exposure is carried out and a second period during which the exposure is suspended, and
wherein the driver is configured to initiate the compensation so as to perform the compensation at least in part of the first period, and to suspend the compensation so as not to perform the compensation at least in part of the second period.

2. The optical image stabilization system according to claim 1, wherein the driver is further configured to move the compensation target object to a predetermined reference position in the second period.

3. The optical image stabilization system according to claim 2, wherein the predetermined reference position is a center of a mechanism for moving the compensation target object.

4. The optical image stabilization system according to claim 2, wherein the predetermined reference position is an optical center of the compensation target object.

5. The optical image stabilization system according to claim 2, wherein the driver is further configured to move the compensation target object to maximize an operable range of the compensation target object in the second period based on a motion of the compensation target object detected in a previous first period.

6. The optical image stabilization system according to claim 5, wherein the driver is further configured to shorten an exposure period in a subsequent frame when the motion of the compensation target object detected in the previous first period exceeds the operable range of the compensation target object.

7. The optical image stabilization system according to claim 2, wherein the driver is further configured to move the compensation target object to the predetermined reference position at a constant speed during a period from an end of the compensation to a start of a next compensation.

8. The optical image stabilization system according to claim 2, wherein the driver is further configured to move the compensation target object such that a period of time during which the compensation target object stops moving at the predetermined reference position occurs during a period from an end of the compensation to a start of a next compensation.

9. The optical image stabilization system according to claim 1, wherein a start time of the compensation is different from a start time of an exposure period.

10. The optical image stabilization system according to claim 1, wherein an end time of the compensation is different from an end time of an exposure period.

11. A camera module comprising:
an optical image stabilization system, comprising:
a detection unit configured to detect motion of a compensation target object in each frame of a moving image, wherein the compensation target object is an optical system, a camera module or an image sensor; and
a driver configured to perform a compensation of a blur of an image by moving the compensation target object so as to cancel the motion of a detected compensation target object,
wherein a period corresponding to each frame includes a first period during which an exposure is carried out and a second period during which the exposure is suspended, and
wherein the driver is configured to initiate the compensation so as to perform the compensation at least in part of the first period, and to suspend the compensation so as not to perform the compensation at least in part of the second period.

12. The camera module according to claim 11, wherein the driver is further configured to move the compensation target object to a predetermined reference position in the second period.

13. The camera module according to claim 12, wherein the predetermined reference position is a center of a mechanism for moving the compensation target object.

14. The camera module according to claim 12, wherein the predetermined reference position is an optical center of the compensation target object.

15. The camera module according to claim 12, wherein the driver is further configured to move the compensation target object to maximize an operable range of the compensation target object in the second period based on motion of the compensation target object detected in a previous first period.

16. The camera module according to claim 15, wherein the driver is further configured to shorten an exposure period in a subsequent frame when the motion of the compensation target object detected in the previous first period exceeds the operable range of the compensation target object.

17. The camera module according to claim 12, wherein the driver is further configured to move the compensation target object to the predetermined reference position at a constant speed during a period from an end of the compensation to a start of a next compensation.

18. The camera module according to claim 12, wherein the driver is further configured to move the compensation target object such that a period of time during which the compensation target object stops moving at the predetermined reference position occurs during a period from an end of the compensation to a start of a next compensation.

19. The camera module according to claim 11, wherein a start time of the compensation is different from a start time of an exposure period.

20. The camera module according to claim 11, wherein an end time of the compensation is different from an end time of an exposure period.
